(19) United States
(12) Patent Application Publication
(10) Pub. No.: US 2023/0281865 A1
(43) Pub. Date: Sep. 7, 2023

(54) SYSTEMS AND METHODS FOR OPTICAL RECOGNITION AND IDENTIFICATION OF OBJECTS, AND INVENTORYING OF THE SAME

(71) Applicant: SLAB DREAM LAB, LLC, Athens, GA (US)

(72) Inventor: Robert Lyle Thompson, Nicholson, GA (US)

(21) Appl. No.: 18/008,102

(22) PCT Filed: Jun. 2, 2021
(86) PCT No.: PCT/US2021/035507

§ 371 Date: Dec. 2, 2022

Related U.S. Application Data
(60) Provisional application No. 63/034,209, filed on Jun. 3, 2020.
(60) Provisional application No. 63/118,413, filed on Nov. 25, 2020.
(60) Provisional application No. 63/118,424, filed on Nov. 25, 2020.
(60) Provisional application No. 63/149,494, filed on Feb. 15, 2021.

(51) Int. Cl. G06T 7/73; G06V 20/60; G06T 7/13; G06T 7/10; G06V 10/75; G06Q 10/087

(52) U.S. Cl. CPC G06T 7/74; G06V 20/60; G06T 7/13; G06T 7/10; G06V 10/751; G06Q 10/087; G06T 2207/30242; G06T 2207/20021

(57) ABSTRACT

A system for object recognition having an imaging device for capturing images of objects; a memory for storing captured images of objects; and a processor for performing object recognition to identify objects in the captured images and managing a database of identified objects in a user inventory. The system is configured to capture and store images, identify objects in the stored captured images, and cross-reference identified objects with a pre-stored library corresponding to a user inventory. The system may further cross-reference the user inventory with a project library to identify projects that a user may complete with the objects identified in their inventory, as well as projects that the user may complete if additional objects are added to their inventory. When identifying projects that may be completed with acquisition of additional objects, the system preferably identifies the additional objects needed for acquisition.

### FIELD OF THE INVENTION

The present invention relates to systems and methods for optical detection and recognition of objects and images, and an intelligent inventory system for the management, identification and recommendation of objects and images. As one example, the present invention addresses a system for the optical detection and recognition of building blocks, and an intelligent inventory system for the management, identification and recommendation of building blocks and building block constructs that may be completed with the building blocks managed by the inventory system.

### BACKGROUND OF THE INVENTION

Interlocking building blocks bricks are old and well known; perhaps the most well-known of which are LEGO bricks, as sold by The LEGO Group under the trademark LEGO®. The LEGO Group was founded in 1932 by Ole Kirk Kristiansen. The company has passed from father to son and is now owned by Kjeld Kirk Kristiansen, a grandchild of the founder. The LEGO brick is their most important product. This was twice “Toy of the Century”. Their products have undergone extensive development over the years—but the foundation remains the traditional LEGO brick. The LEGO brick in its present form was launched in 1958; and granted U.S. Pat. No. 3,005,282, the content of which is incorporated herein in its entirety.

LEGO bricks and other building blocks, continue to have a strong following, both with young children that are just developing fine motor control and hand-eye coordination, as well as long time enthusiasts who seek to construct ever more complex assemblies. The complexity of building block constructs that may be assembled is limited only by the imagination of the user; and enthusiasts often enjoy in sharing their creations with others and learning of yet more complex constructs that they themselves may assemble. However, currently there is not a convenient means for researching new building block constructs, with users instead finding themselves often forced to resort to tedious online searching.

Accordingly, there remains a need in the art for a convenient means by which building block users may learn of new building block constructs, without requiring extensive researching.

### SUMMARY OF THE INVENTION

A system for optical recognition of building blocks comprises an imaging device configured to scan and capture images of objects (e.g., building blocks); a memory processing application and/or physical unit configured to store, process and identify captured images of building blocks; and a processor configured to perform object and image recognition and classification on images of building blocks. The system is configured for the imaging device to communicate with the processor and memory for conveying captured images of building blocks for processing and storage in the memory, and for the processor to access and perform object and image recognition on captured images stored in the memory to identify and classify individual building blocks in the captured image.

The processor is configured, in performing object and image recognition, to perform: object detection, analysis and classification to identify individual building blocks in the captured image, and establish an inventory detailing the style, color, part, identity and count of all identified building blocks and a count of each different building block type identified; localization to determine an edge-pixelated location for each of the individual building blocks identified in the captured image; bounding in which edges and pixels are identified for defining the perimeter, quality and color of each individual building block detected and localized in the captured image; segmentation to classify, isolate and extract a local or new image for each of the individual building blocks detected, localized and bound in the captured image; and matching between the extracted images of the building blocks and pre-stored images in the memory to match the extracted images with corresponding pre-stored images, and, upon a successful matching of an extracted image with a pre-stored image, to designate the building block in the extracted image as a pre-defined building block type that is associated with the corresponding pre-stored image.

The processor is further configured, when matching between scanned images of building blocks in captured images and pre-stored images in a memory, to classify, recommend, match and personalize the captured images with corresponding pre-stored model/image and to then designate the building block in the captured image as a pre-defined building block type associated with the corresponding pre-stored model/image.

The processor is further configured, following identification of individual building blocks in a captured image, to generate a user inventory identifying and classifying a type of each building block identified in the captured image and a quantity of each building block type. The user inventory manages building blocks based on identity, classification, and characteristics (e.g., color, style, grouping, theme, size, quality).

The processor cross-references the user inventory of building blocks with a pre-stored library of projects (e.g., block constructs) to identify a list of block constructs that may be assembled with the building blocks available in the user inventory and provides the user with a list of building blocks needed for assembling a block construct from the pre-stored library together with instructions for assembling the block construct. The user inventory may also be cross-referenced with user inventories of other users to provide a list of block constructs that may be assembled through shared use of building blocks from the two or more user inventories.

When cross-referencing a user inventory of building blocks with a pre-stored library of block constructs, the processor will compare the user inventory of building blocks with a build inventory of building blocks required for assembling a block construct and will identify building blocks that are required by the build inventory and missing from the user inventory. When identifying missing blocks that are required for a block construct, the processor may also provide a means for a user to acquire the missing building blocks, for example, by providing contact information for the original equipment manufacturer or one or more third parties that are offering the missing building blocks for sale or providing a link to an internet accessible website where the missing building blocks are available for purchase.

Both the foregoing general description and the following detailed description are exemplary and explanatory only and are intended to provide further explanation of the invention as claimed. The accompanying drawings are included to provide a further understanding of the invention; are incorporated in and constitute part of this specification; illustrate embodiments of the invention; and, together with the description, serve to explain the principles of the invention.

### BRIEF DESCRIPTION OF THE DRAWINGS

Further features and advantages of the invention can be ascertained from the following detailed description that is provided in connection with the drawings described below:

FIG. 1 shows an example of a system according to the present invention;

FIG. 2 shows an object recognition sequence executed in the system in FIG. 1;

FIG. 3 shows an example of building blocks being imaged by an imaging device of the system in FIG. 1;

FIG. 4 shows an image collection unit of the system in FIG. 1;

FIG. 5 shows an autoencoder of the system in FIG. 1;

FIG. 6 shows a multi-model compression process using the autoencoder in FIG. 5;

FIG. 7 shows a process for training an object recognition algorithm in the system in FIG. 1;

FIG. 8 shows a process for testing an object recognition algorithm in the system in FIG. 1;

FIG. 9 shows a process for generating an image from images input to the system in FIG. 1;

FIG. 10 shows a process for generating a feature vector database in the system in FIG. 1;

FIG. 11 shows a process for object prediction with a feature vector database in the system of FIG. 1;

FIG. 12 shows a process using pixel aggregation in the in the system in FIG. 1;

FIG. 13 shows an image classification process in the system in FIG. 1;

FIG. 14 shows a Content-Based Image Retrieval (CBIR) process in the system in FIG. 1;

FIG. 15 shows a flow chart for a CBIR operation in the system in FIG. 1;

FIG. 16 shows an object management system in the system in FIG. 1; and

FIG. 17 shows a computing device of the system in FIG. 1.

### DETAILED DESCRIPTION OF THE INVENTION

The following disclosure discusses the present invention with reference to the examples shown in the accompanying drawings, though does not limit the invention to those examples.

The use of any and all examples, or exemplary language (e.g., “such as”) provided herein is intended merely to better illuminate the invention and does not pose a limitation on the scope of the invention unless otherwise claimed. No language in the specification should be construed as indicating any non-claimed element as essential or otherwise critical to the practice of the invention, unless otherwise made clear in context.

As used herein, the singular forms “a,” “an,” and “the” include plural referents unless the context clearly dictates otherwise. Unless indicated otherwise by context, the term “or” is to be understood as an inclusive “or.” Terms such as “first”, “second”, “third”, etc. when used to describe multiple devices or elements, are so used only to convey the relative actions, positioning and/or functions of the separate devices, and do not necessitate either a specific order for such devices or elements, or any specific quantity or ranking of such devices or elements.

The word “substantially”, as used herein with respect to any property or circumstance, refers to a degree of deviation that is sufficiently small so as to not appreciably detract from the identified property or circumstance. The exact degree of deviation allowable in a given circumstance will depend on the specific context, as would be understood by one having ordinary skill in the art.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless indicated herein or otherwise clearly contradicted by context.

Unless indicated otherwise, or clearly contradicted by context, methods described herein can be performed with the individual steps executed in any suitable order, including: the precise order disclosed, without any intermediate steps or with one or more further steps interposed between the disclosed steps; with the disclosed steps performed in an order other than the exact order disclosed; with one or more steps performed simultaneously; and with one or more disclosed steps omitted.

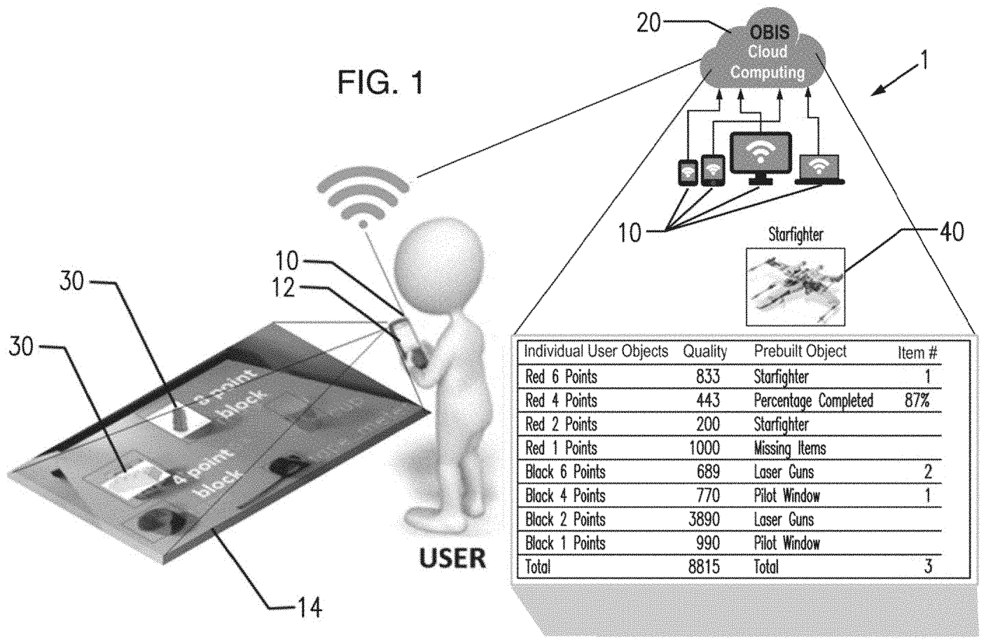

FIG. 1 shows an example of a system 1 according to the present invention, as seen from a user perspective. The system 1 is inclusive of an imaging device 12 that is in signal communication with a processor 20. The imaging device 12 communicates with the processor 20 for conveying captured images of objects 30, and the processor 20 performs object recognition on the captured images to identify objects 30 in the captured images and creates a user-specific inventory of objects identified in images captured by the specific user in a user-specific database 512.

The imaging device 12 is provided in a user device 10 and is adapted for capturing images of one or more objects 30 (e.g., building blocks). The imaging device 12 is adapted to scan, capture and classify an image of one or more objects, and may be provided in the form of a camera on a personal computer, or in a handheld wireless device, such as a smartphone or smart watch. In one example, the imaging device 12 operates together with a capture application that is adapted for providing a frame of reference for locating, scanning and imaging of objects. In some examples, the capture application may be provided as a physical object in the form of a capture board 14 (as seen in FIG. 1), with the physical board having predetermined boundaries that define a capture region and optionally one or more markings that serve as image references to determine a scale of objects 30 that are placed on the physical board and captured in an image. In other examples, the capture application may be a software application on the imaging device, without need of a physical component.

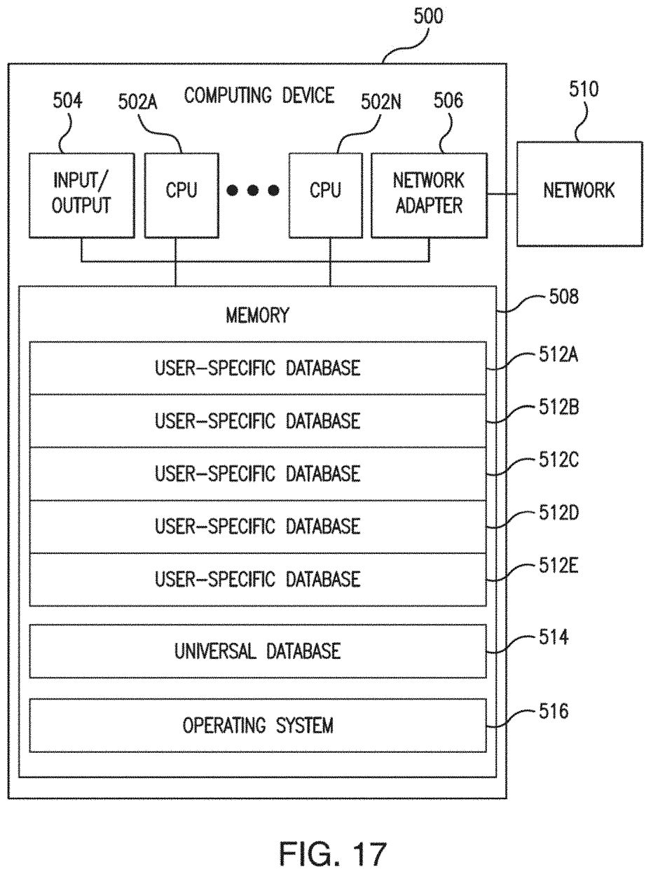

The processor 20 is in signal communication with one or more imaging devices 12, through respective user devices 10, for reception of captured images. The processor 20 is configured to perform object recognition to identify, analyze, and inventory individual objects 30 in received captured images; and to store data on the identified objects 30 in a user inventory at a user-specific database 512 (FIG. 17). The processor 20 also compares user inventories with a library at a universal database 514 (FIG. 17) to identify potential projects (e.g., block constructs) that may be completed with objects in a user inventory.

In operation, a user may position a number of objects 30 in a capture region, with each object laid out flat and separately from one another and will use the imaging device 12 to capture one or more images of the objects 30. If using a capture board 14, the user may position the objects 30 indiscriminately in the capture region defined thereby. The imaging device 12 may capture images of the objects 30 as still images and/or real-time image feeds (e.g., video feeds). Images captured by the imaging device 12 are stored, classified, and inventoried in a user-specific database 512 that is unique to the specific user. The user-specific database 512 also stores a record of all objects 30 identified in the stored images and preferably further records a number of identifying characteristics of each recorded object 30.

Image capturing may be performed in a single step, with all objects 30 imaged in a single still image or a single image feed; or may be performed in multiple steps, with multiple still images or image feeds captured and consolidated in the user-specific database 512 to identify all objects 30 in the user's possession. The number of steps needed for recording the objects 30 may vary depending on the number of objects 20 to be imaged, and the size of the capture region. Image capturing may be performed on multiple occasions, over a period of time, with the user-specific database 512 updated with the newly captured images, objects, and object characteristics on each occurrence.

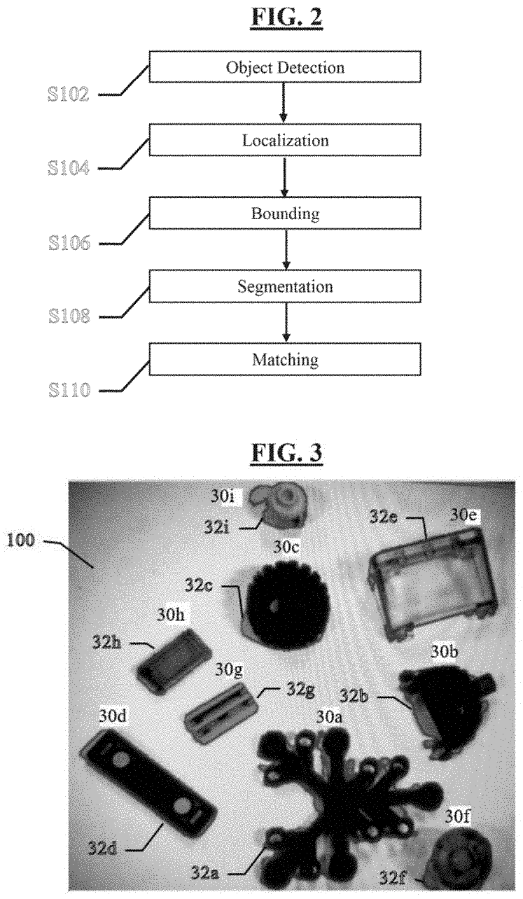

The processor 20 is configured to access the user-specific database 512 to perform object recognition on captured images stored therein, to identify individual objects 30 in each captured image. As shown in the example illustrated in FIGS. 2-3, the processor 20 may perform object recognition through a sequence of steps that include: object detection; localization; bounding; segmentation; and matching. In an object detection step S102, the processor 20 will analyze a captured image 100 to identify individual objects 30a-30i imaged therein, and to establish a count of each identified object 30. The processor 20 will then perform a localization step S104, to determine locations for each of the individually identified objects 30a-30i; and a bounding step S106 to identify edges defining perimeters 32a-32i of each respective object 30a-301. In a subsequent segmentation step S108, the processor 20 isolates and extracts a local image of each individually identified object 30a-30i. Thereafter, in a matching step S110, the processor 20 cross-references the extracted images with pre-stored images in a universal database 514 to match the extracted images with pre-stored images. Upon successful matching of an extracted image with a pre-stored image, the processor 20 designates the object 30a-30i in the respective extracted image with a pre-defined object type that is associated with the corresponding pre-stored image with which the respective extracted local image was matched.

The processor 20 may perform object recognition through machine vision algorithms, in which pixilated images are examined to identify edges, clusters and dimensions of pre-defined shapes. Examples of suitable machine vision algorithms include, though are not limited to ImageNet, CBIR, MobileNet, Cognex VisionPro, Omron VisionScape, Adaptive Vision Software, HALCON, MATLAB, SimpleCV, WEKA, AForge, and VLFeat. A further discussion as to machine vision algorithm is provided by A. G. Howard, et al., Mobilenets: Efficient Convolutional Neural Networks for Mobile Vision Applications, arXiv:1704.04861, 2017, the entire contents of which are incorporated herein by reference. The processor 20 may also perform object/image recognition through use of an artificial intelligence algorithm to identify individual objects through a number of characteristics that are taught by a training database, such as element shape, color, position, surface texturing, etc. Examples of suitable artificial intelligence algorithms include, though are not limited to: YOLO, R-CNN, and SSD Object Detector.

Following object recognition from captured images in a user-specific database 512, with identification and counting of individual objects 30 in the captured images, the processor 20 will generate a user inventory identifying a type for each identified object 30 in the user's possession, as well as a quantity of each identified object type. Preferably, the user inventory of objects, object types, and object type counts is also stored in the user-specific database 512. If the user subsequently performs further image capturing of additional object 30, then the processor 20 may repeat the object recognition processing on the newly added captured images and may update the user inventory to add all newly identified object, object types, and object type counts.

Once the processor 20 has generated a user inventory of a user's available objects 30, the user may request that the processor 20 provide a listing of available projects that may be completed with the objects in the user inventory. Upon such request, the processor 20 reviews an object library in the universal database 514 that is inclusive of a pre-stored listing of projects that can be completed with predetermined sets of objects, with each project having a corresponding project inventory that identifies all object types and corresponding quantities of each object type that is needed to complete the respective project.

Upon receiving a listing of projects, a user may select a desired project and the processor 20 will then provide the user with one or more images of the selected project; a parts list identifying each object type and the corresponding quantities of each object type needed to complete the project; and step-by-step instructions for completing the project. When providing the user with details of a selected project, the processor 20 may further compare the user inventory to the project inventory of the selected project and may identify any object types and/or quantities that are missing from the user inventory that will be needed for completing the project.

FIG. 1 illustrates one example of a user employing a system 1 according to the present invention in use with objects 30 in the form of building blocks for use in completing one or more projects in the form of a block construct (e.g., a construction formed from multiple building blocks 30). In this example, the user operates a user device 10 to request a listing of block constructs and selects a block construct 40 labeled “Starfighter”, for building a space craft.

On receiving the request from the user, the processor 20 compares the user inventory to the build inventory for the Starfighter construct and identifies the building blocks 30 in the user's possession (e.g., “Individual User Objects”), along with a count of each building block type (e.g., “Quantity”). The process 20 further identifies any building blocks 30 that are necessary for assembling the selected Starfighter construct, and which are missing from the user's inventory, along with a count for each missing building block type. In the example shown in FIG. 1, the processor 20 informs the user that they are missing two building block types (e.g., “Prebuilt Object”, “Missing Items”) in the form of “lazer guns” and “pilot window” building blocks; and further identifies a count for each missing building block type (e.g., Item #)—specifically, two “lazer guns” building blocks and one “pilot window” building block.

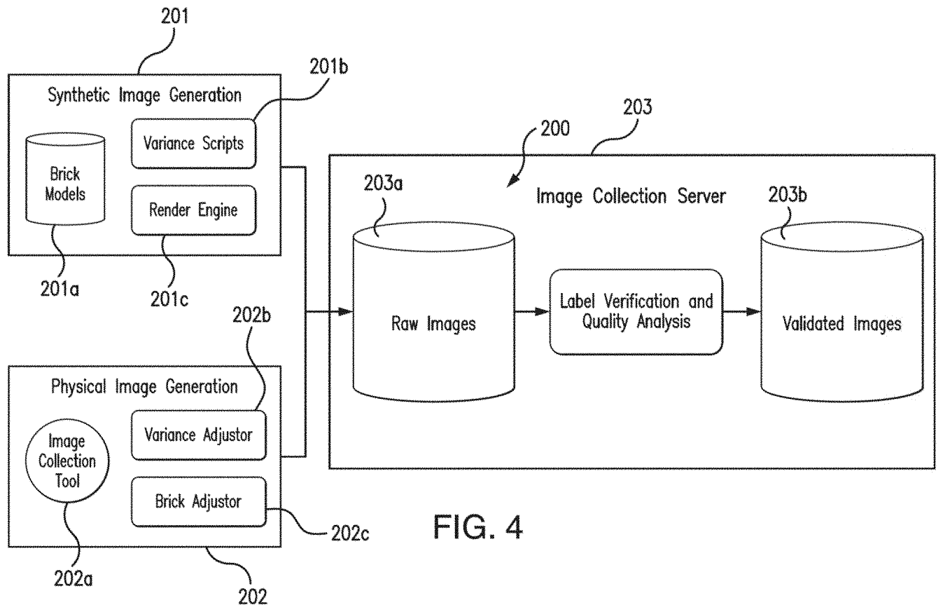

FIG. 4 shows an example of an image collection unit 200 that may be provided with the processor 20 of the system 1. In this example, the image collection unit 200 includes a synthetic image generator 201, a physical image generator 202, and an image collection server 203. The synthetic image generator 201 generates synthetic images (e.g., images of simulated objects), the physical image generator 202 generates physical images (e.g., images of physical objects), and the image collection server 203 receives and validates synthetic images from the synthetic image generator 201 and physical images from the physical image generator 202.

The synthetic image generator 201 includes a model database 201a that stores pre-determined and pre-loaded base models of a plurality of object types (e.g., building block types), a variance database 201b that stores pre-determined and pre-loaded variance scripts, and a rendering engine 201c that is programmed to generate three dimensional models from the base models in the model database 201a and to employ the variance scripts from the variance database 201b to vary the appearance of the three dimensional models and to generate a multitude of two dimensional images of the three dimensional models with the varied appearances.

The model database 201a stores pre-determined and pre-loaded base models of a plurality of object types, each base model containing the dimensions of a given object from the plurality of object types, including all necessary dimensions for generating a digital three-dimensional model that simulates the corresponding object. The dimensions provided in a base model include, though are not limited to, the lengths of each edge of an object and the angles between adjacent edges. Base models for more complex objects may include additional dimensions, such as radii of curvature of curved surfaces, slope angles of sloped surfaces, etc. The dimensions provided in a base model may also include all dimensions needed for accurately modeling the connector pieces (e.g., mating nodes and barrels in building blocks) provided on each object that facilitate mating engagement of the object with one or more other objects.

A typical base model will include all necessary dimensions for generating a three-dimensional model of a single object, though some base models may include all necessary dimensions for generating a three-dimensional model of two or more objects that are engaged with one another. For example, in instances where two or more objects are closely associated with one another (e.g., in that they are most commonly used in a physical connected state with one another) then a single base model may include the dimensions for generating a three-dimensional model in which the two objects are connected with one another. Optionally, the model database may include base models that do not include all necessary dimensions for generating a complete three-dimensional model of an object and may instead include only certain dimensions that are needed for generating a low fidelity three-dimensional model of the object that provides sufficient detail for modeling and/or identifying only certain unique and/or distinctive characteristics of the object.

The variance database 201b stores pre-determined and pre-loaded variance scripts that each provide model modifiers for altering one or more visual characteristics of three-dimensional models generated from the base models stored in the model database 201a. Model modifiers provided in a variance script may include, though are not limited to, lighting modifiers, background modifiers, texturing modifiers, and color modifiers. A single variance script may have a single modifier of a single modifier class (e.g., a single color; or a single texture) or may have a plurality of multipliers, either of a single class (e.g., three colors; or five textures) or multiple modifier classes (e.g., three colors, five textures, and two lighting effects).

The rendering engine 201c is programmed to import base models from the model database 201a and generate a digital three-dimensional model from each imported base model, and to then import one or more variance scripts from the variance database 201b and execute the imported scripts to successively modify the visual characteristics of the generated model. The render engine 201c is further programmed to generate one or more two dimensional images of each different visual appearance of the generated model that results from executing the one or more variance scripts. For example, in an instance when an imported variance script contains ten different lighting modifiers, ten different background modifiers, ten different texturing modifiers, and ten different color modifiers, the rendering engine 201c may execute that imported variance script to generate a visual appearance of the three-dimensional model that corresponds with each permutation of those several modifiers (i.e., 10⁴ different appearances of a building block).

The rendering engine 201c will generate at least one two-dimensional image of each separate visual appearance of the three-dimensional model based on the several permutations of the variance script, though may generate two or more such images for each separate visual appearance. For example, the rendering engine 201c may generate a single two dimensional image of each separate visual appearance of the three dimensional model (i.e., 1×10⁴ images) as viewed from a single perspective (e.g., a top plan view) or may generate seven two dimensional images of each separate visual appearance (i.e., 7×10⁴ images) as viewed from seven different perspectives (e.g., top plan view, bottom plan view, right side elevation view, left side elevation view, front elevation view, rear elevation view, and isometric view).

The physical image generator 202 includes an image collection tool 202a for capturing images of a physical object, a variance adjustor 202b for altering characteristics of images captured by the image collection tool 202a, and an object adjustor 202c for iterating through different objects and positions.

The image collection tool 202a provides an interface for capturing, labeling, and transmitting images of physical objects that is inclusive of an image capture device. The image capture device may be any device that is capable of capturing electronic images of physical objects and may include devices that capture static images (e.g., a snapshot camera) or motion images (e.g., a video camera). Non-limiting examples of image capture devices include a standalone camera device, a camera incorporated into a handheld device, a camera incorporated into a computer, etc. The image collection tool 202a is provided with a local memory that stores captured images as well as one or more programs for labeling captured images, a local processor for executing the locally stored programs, and a user interface for interacting with captured images and the image labeling programs. In some examples the image collection device 202a may be a locally integrated component of the image collection unit 200, and thus the processor 20 (e.g., a local imaging station); and in other examples the image collection device 202a may be a remote component that is in remote communication with the image collection unit 200, and thus the processor 20 (e.g., the remote user device 10 of system 1 with an integrated imaging device 12).

The variance adjustor 202b stores pre-determined and pre-loaded variance scripts that each provide image modifiers for altering one or more visual characteristics of images captured by the image collection tool 202a. Image modifiers provided in a variance script of the variance adjustor may include, though are not limited to lighting modifiers and background modifiers. In some examples, the variances scripts stored at the variance adjustor 202a may be the same as the modifiers stored at the variance database 201b, which may further include, though are not limited to texture modifiers and color modifiers. A single variance script may have a single modifier (e.g., a single lighting effect; or a single background) or may have a plurality of multipliers, either of a single modifier class (e.g., three lighting effects; or five backgrounds) or multiple modifier classes (e.g., three lighting effects, five backgrounds, and two texture effects).

The object adjustor 202c imports physical images from the image collection tool 202a and one or more variance scripts from the variance adjustor 202b, and then executes the imported scripts to successively modify the positions and visual characteristics of the physical images. The several variations of a common physical image (e.g., witch varying combinations of positional and characteristics modifiers) are grouped together as a family of collected images for that common physical image. The scope and degree of variations made possible by the object adjustor 202c may be the same as that made possible by the rendering engine 201c of the synthetic image generator 201.

The image collection server 203 includes a raw image database 203a and a validated image database 203b. The raw image database 203a stores synthetic images received from the synthetic image generator 201 and physical images received from the physical image generator 202, and the validated image database 303b stores images received from the raw image database 203a following verification.

The raw image database 203a receives and stores synthetic images from the synthetic image generator 201 and physical images from the physical image generator 202. Synthetic images received from the synthetic image generator 201 may be stored in associated synthetic image collections, in which synthetic images of a common object that each contain one or more variances from one another are each stored in a common collection. For example, when the synthetic image generator 201 may generate a plurality of images from a single three-dimensional model of a common base model (e.g., 10⁴ images, 7×10⁴ images, etc.), and each of those commonly sourced and varied images may then be stored in a common collection associated with the base model from which those varied images were generated. Likewise, physical images received from the physical image generator 202 may also be stored in associated physical image collections, in which physical images of a common object that each contain one or more variances from one another are each stored in a common collection. For example, when the physical image generator 202 generates a plurality of varied images from a single captured image of a common physical object, then all of those commonly sourced and varied images may be stored in a common collection that is associated with the physical object from which those varied images were generated.

A verification and quality analysis are made of the images stored in the raw image database 203a, and the images judged to meet verification and quality assurances are stored in the validated image database 203b. The validated image database 203b may store images in a similar manner as in the raw image database 203a (e.g., with associated images stored in common collections), or in a different manner therefrom.

In operation, a user may operate the image collection tool 202a (e.g., imaging device 12) to capture one or more images of an object 30, which may include several images at different angles. The user may manipulate or otherwise edit the images using the object adjustor 202c and variance adjustor 202b. Images are then transmitted to and archived at the image collection server 203. The processor 20 employs an intelligent object recognition algorithm to detect objects in the archived images, determine characteristics (e.g., shape, color, lighting, etc.) and accuracy of the individual detected objects, and recommend identifications and classifications of the individual detected objects (e.g., identification of specific building blocks and classification of one or more building block types for each building block).

In one example, the object recognition algorithm extracts data from the captured images, such as an overall shape, vertical and horizontal edges, and individual pixels, and processes the extracted data to generate estimation rarity and quality scores that are used to determine an accuracy of the extracted data in identifying individual objects and object types. For example, the object recognition algorithm may verify if extracted shapes, edges and pixels contains one or more particular colors (e.g., grey-scale or vibrant color pixel distinctions), and may use the color details to determine if an extracted shape, edge and/or pixel belongs belong to a specific object or object type based on prior recorded object data.

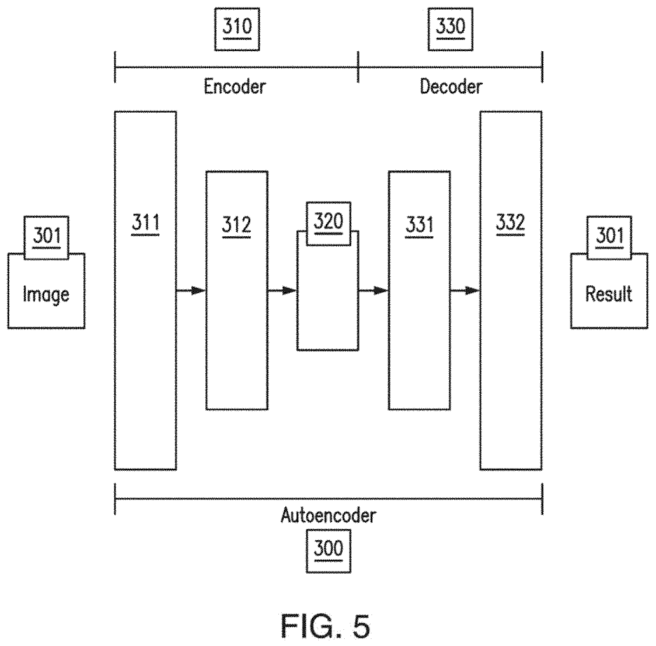

An object recognition algorithm according to the present invention may be employed, for example, through use of an autoencoder 300, such as that shown in FIG. 5. The autoencoder 300 includes two portions, an encoder 310 and a decoder 330. The encoder 310 operates to receive data and to compress that data to a reduced size for storage, whereas the decoder 330 operates to retrieve stored compressed data and expand the data back to the original uncompressed state.

When used in a system according to the present invention, the autoencoder 300 may receive data in the form of a captured image 301 which is then subject to first and second input layers 311, 312 to yield a reduced dimension data feature (e.g., a single dimension vector). The captured image 301 is reduced in size by a first level data extraction at the first input layer 311 and is then further reduced in size by a second level data extraction at the second input layer 312. In the first level data extraction at the first layer 311, there is identified and extracted a number of features from the captured image 301 that are deemed to reliably identify that particular image. Then in the second level data extraction at the second layer 312, there is identified and extracted a number of features from the first set of extracted features that are deemed to reliably identify that set of features. A further discussion as to feature extraction is provided by A. G. Howard, et al., Mobilenets: Efficient Convolutional Neural Networks for Mobile Vision Applications, arXiv:1704.04861, 2017, the entire contents of which are incorporated herein by reference. The extracted features resulting from the second layer 312 are then stored as a compressed data set 320.

Upon receiving a subsequent query to retrieve stored compressed data, such as a compressed captured image 301, the compressed data set 320 is accessed and passed through first and second output layers 331, 332 to expand the data to the original uncompressed state. The compressed data 320 is expanded in size by a first level data resampling at the first output layer 331 and is then further expanded by a second level data resampling at the second output layer 332. In the first level data resampling at the first layer 331 the compressed data 320 is input for resampling into a first expanded data set, and in the second level data resampling at the second layer 332 the first expanded data set output forms the first layer 331 is input for resampling into the original capture image 301.

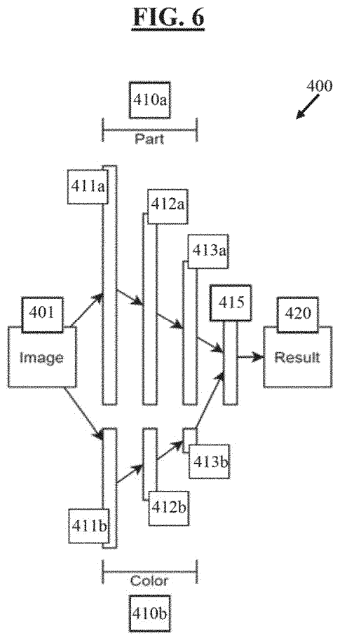

The autoencoder 300 may operate with a multi-model compression, in which separate characteristics of a captured image 301 are processed separately to identify and extract features relevant to each of the separate characteristics, with the several extracted features then consolidated in the user-specific database for use in object identification, classification and recognition. One example of multi-model compression 400 is shown in FIG. 6, in which a captured image 401 is processed relative to both a “part” characteristic 410a and a “color” characteristic 410b. In this example, the separate characteristics 410a/410b of the captured image 401 are reduced in size by multiple levels of data extraction, with the “part” characteristic 410a going through three layers of data extraction 411a/412a/413c, and the “color” characteristic 410b likewise going through three layers of data extraction 411b/412b/413b. Extraction of the separate characteristics proceeds as previously discussed with the output from a prior layer of extraction (e.g., 411a/411b) serving as the input to a subsequent layer of extraction (e.g., 412a/412b). Once the separate characteristics 410a/410b have each completed each of their respective extraction layers, the final set of extracted features from each characteristic are then combined into a final set of extracted features 415 which is then stored as a compressed data set 420.

A multi-model compression 400 may provide a benefit in that it ensures extraction of features for each of a predefined number of characteristics, thereby promoting the generation of compressed data sets 420 (320) that contain data on characteristics that were identified in advance as especially useful in responding to a query to resample an original captured image 401 (301). Though the foregoing discussion and illustration in FIG. 5 address an example of an autoencoder 300 in which the encoder 310 and decoder 330 have two layers each, it will be understood that an autoencoder may have any number of layers in the encoder 310 and decoder 330, including a single layer or several layers. Likewise, though the foregoing discussion and illustration in FIG. 6 address an example of a multi-model compression 400 in which each characteristic 410 has three layers each, it will be understood that a multi-model compression may have any number of layers for each separate characteristic 410, including a single layer or several layers.

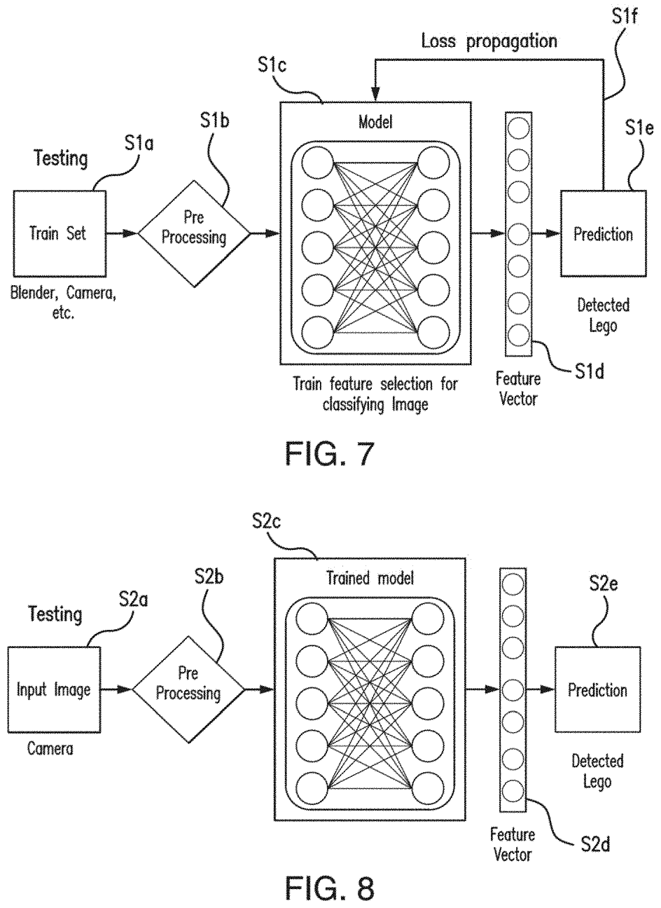

FIG. 7 shows one example of a training process for training an object recognition algorithm. In this example, the training process includes steps of receiving a training image set (S1a); pre-processing images in the training set (S1b); selecting key features from images in the training set for image classification (S1c); identifying feature vectors of the selected key features (S1d); and predicting object types using the feature vectors to identify image classifications (S1e). Optionally, the training process further includes a loss propagation loop (S1f) for returning prediction results from step S1e to the feature selection step S1c for iteratively improving the selection of key features for image classification.

In the step S1a, a training image set is received. In the step S1b, the images in the training set are pre-processed. In the step S1c, one or more features are selected from the processed training images as key features for use in image classification. In the step S1d, a feature vector is generated for each feature that was selected from the training images for use in image classification. In the step S1e, the feature vectors are associated with and used to identify associated image classifications to make predictions of an object type that is shown in an image. In the step S1f, an optional loss propagation loop is used for returning prediction results to the feature selection step S1c for iteratively improving the selection of key features for image classification.

Pre-processing of this data for object recognition and image detection involves the integration, cleansing, and transformation of image feeder data. Data cleaning ensures missing and corrupt data is recaptured to ensure a clean, balanced and properly labeled dataset with feature extraction metadata key metrics and variables. Noise removal is done with clustering and segmentation of data, cluster averaging is used to spot outliers for their removal, manual inspections including Euclidean distance measurements are used to detect and eventually remove duplicate data, and data inconsistencies, or other possible scenarios that might confuse the model, are analyzed using confusion matrixes. Feature scaling is performed using Mean, Min-Max, or Z-Score normalization. Image data may be normalized from integer values of [0-255] to floating-point values of [−1, 1], based on the type of model employed. No dimension reduction or expansion is performed. Images are randomly shuffled then split 80% for training and 20% for validation and backpropagation.

Data Augmentation is used to increase the amount of data and prevent overfitting by making modifications to copies of data. Two rounds of augmentation occur before data is input to the model for fitting. In a first round images are horizontally and vertically flipped and rotated from −90° to 90°, and the image itself is then translated between −0.1% and 1.0% within the image frame where the padded pixel data is copied from other areas of the image background to maintain data dimensionality with consistency. In a second round of augmentation images are again flipped horizontally and vertically flipped and again rotated from −90° to 90°, and additional image translation is made along the X and Y axes, with identity, Gaussian blur, and channel multiplication. All rotation and scaling operations are randomized within the stated ranges.

In one example of an object recognition algorithm, synthetic, mutated, and transparent objects are used in blended 2D/3D synthetic images representing real world objects. Transparent backgrounds create a fully labeled and classified set of real-world identifiable objects. Combining and integrating the synthetic object images with physical object images enables the integration of a plurality of classifiable images that include proper labels and classifications that indicate a number of characteristics of the imaged real-world objects, such as though not limited to object identification, class, shape, color(s), etc.

Accuracy predictions are tested, trained and verified by reducing a loss function having first and second portions. A first portion of the loss function indicates a dissimilarity between actual labels of a fully labeled training image from the set of fully labeled training images and predicted classifications for the fully labeled training image; and a second portion of the loss function indicates a dissimilarity between actual labels of a partially labeled training image from the set of partially labeled training images and predicted classifications for the partially labeled training image.

The first portion of the loss function includes a classification loss indicating a dissimilarity between a predicted classification of one or more objects in the fully labeled image and an actual classification of the one or more objects in the fully labeled image, and a localization loss indicating a dissimilarity between a set of predicted shapes, colors, pixels for the one or more objects in the fully labeled image and the set of actual bounding box coordinates for the one or more objects in the fully labeled image. The second portion of the loss function includes a classification loss indicating a dissimilarity between a predicted classification of one or more objects in the partially labeled image and an actual classification of the one or more objects in the partially labeled image.

FIG. 8 shows one example of a testing process for testing a trained object recognition algorithm. In this example, the testing process begins with the reception of one or more testing images (S2a), and pre-processing of the received testing images (S2b). Following pre-processing, one or more features are selected from the testing images as key features for use in image classification (S2c), and the feature vectors are identified for the selected key features (S2d). The feature vectors are then used to identify an image classification and make a prediction as to an object or object type in the testing image (S2e). The prediction (S2e) is then compared to the input testing image (S2a) to assess the accuracy of the trained algorithm.

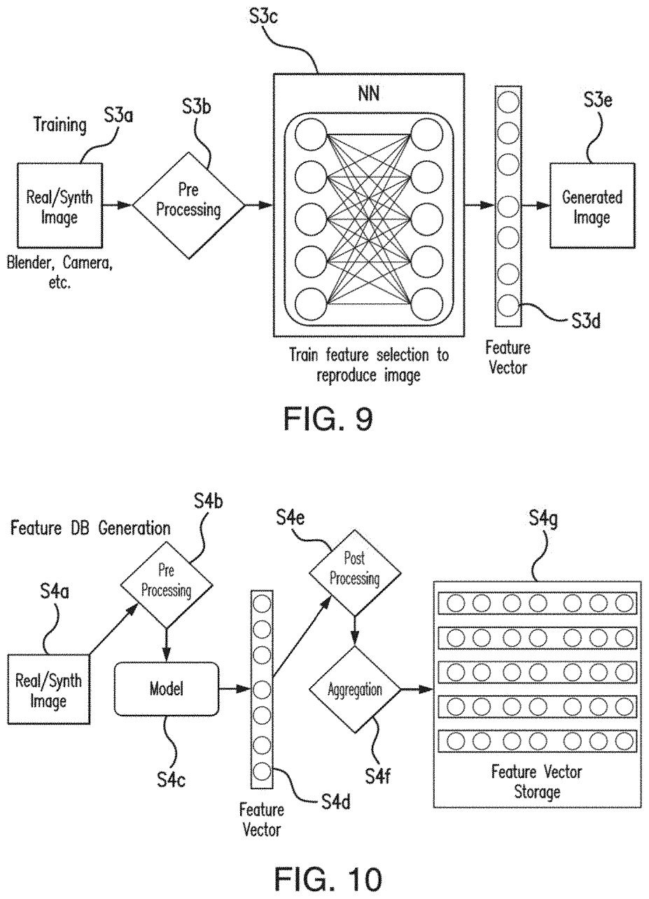

FIG. 9 shows an example of a training process for generating an image from real and/or synthetic images input through an image collection unit 200. In this example, the training process begins with reception of a real or synthetic image (S3a), and pre-processing of the received images (S3b). Following pre-processing, one or more features are selected from the received images for use in reproducing the image (S3c), and features vectors of the selected key features are then identified (S3d). A reproduction of the received image is then generated based on the identified feature vectors (S3e). The generated image (S3e) is then compared to the input image (S3a) to assess the accuracy of the trained algorithm.

FIG. 10 shows an example of a feature vector learning process for the generation of a feature vector database. In this example, the learning process begins with reception of a real or synthetic image (S4a), and pre-processing of the received images (S4b). The processed images are then modelled (S4c), and one or more feature vectors is generated for each image/model (S4d). The feature vectors are then further processed (S4e), and aggregated (S4f). The aggregated feature vectors for the image/model are then stored in a feature vector database (S4g).

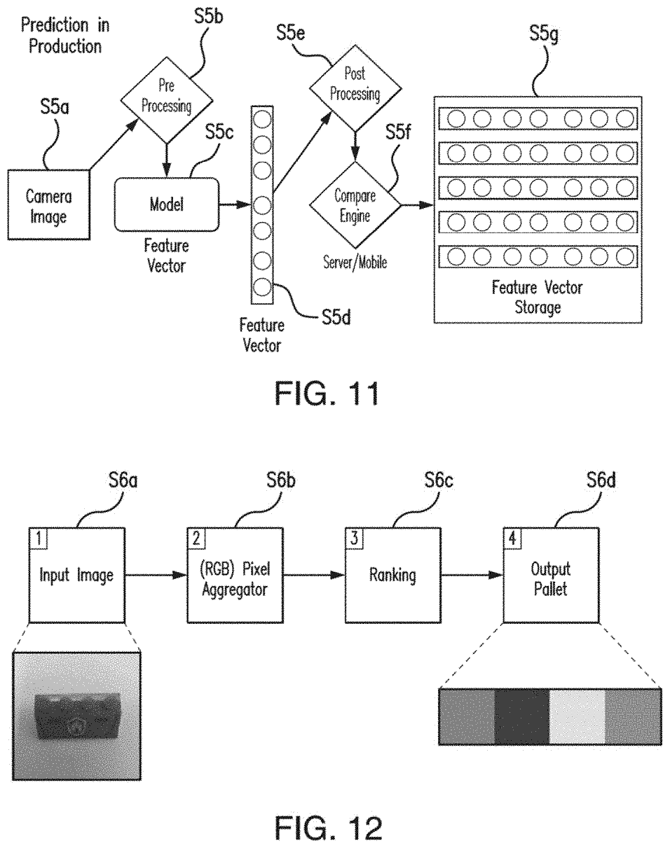

FIG. 11 shows an example of a prediction process for predicting an object or object type with use of a feature vector database. In this example, the prediction process begins with reception of one or more images (S5a), and pre-processing of the received images (S5b). The processed images are then modelled (S5c), and one or more feature vectors is generated for each image/model (S5c). The feature vectors are then further processed (S5e) and a comparison engine then compares the processed feature vectors (S5f) to feature vectors stored in a feature vector database (S5g).

FIG. 12 shows an example of a prediction process in which one or more images are received from a user input (S6a), and pixel aggregation (S6b) is performed to combine one or more clusters of pixels in the received image into individual representative pixels (S6B). Pixel ranking (S6c) is then performed to assess all RGB pixels to find the most common existing pixels, and to then sort those pixels (e.g., in a descending order). The sorted and ranked RGB pixels are then used to generate a color pallet in which the separate RGB values are mapped to a hex color code (S6d).

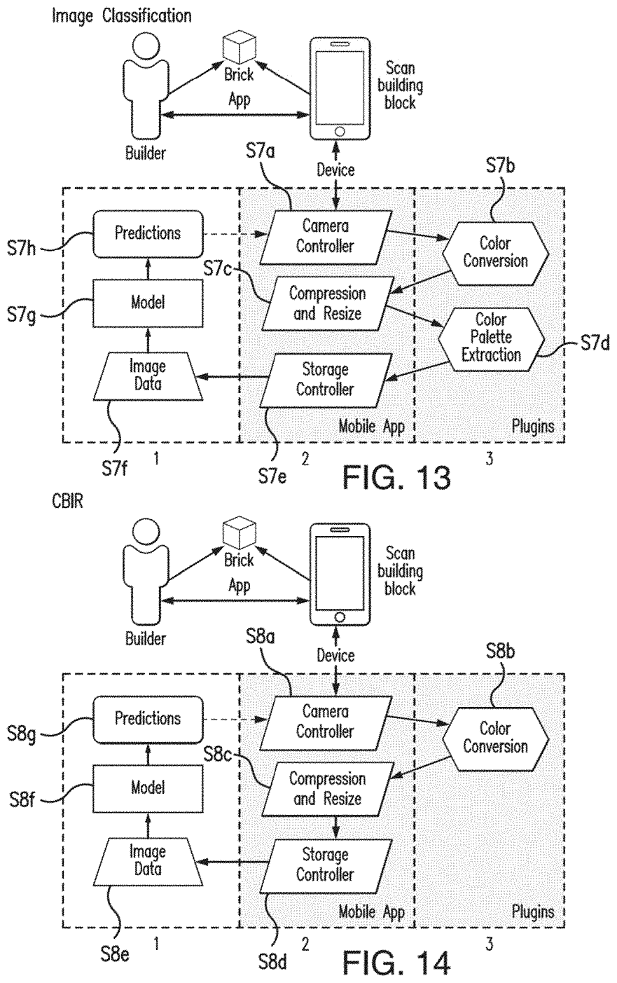

FIG. 13 shows an example of an image classification process. In this example, a classification process begins with a user operates an image capture device, such as a camera control on a handheld device, to capture an image of an object (S7a). The user may use any suitable image capture device that is adapted for communicating with the object detection programming. A color conversion (S7b) is then executed based on the device data format, and data compression and resizing (s7c) is executed to remove exchangeable image file (EXIF) data and crop the captured images to be within predefined dimensions, and a color palette is extracted from the captured images (S7d). A storage controller (S7e) then controls the storage of relevant image data in image data storage (S7f), and a modelling program (S7g) is executed to model the images and extract features from the images/models. Predictions as to the objects and/or object types in the images are then made from the modelling (S7h), and top predictions are displayed to the user at a user interface of the capture device for selection by the user (S7a). Image and object classification post-processing includes storing or indexing the feature vectors extracted from the models as an array with statistical numbers for future distance calculations.

FIG. 14 shows an example of a Content-Based Image Retrieval (CBIR) process that proceeds in substantially the same manner as the image classification process (FIG. 13), with the exception that the CBIR process does not include a color palette extraction (such as that in step S7d); instead, in the CBIR process, the compressed and resized image data (S8cc) is immediately sent to the storage controller (S8d).

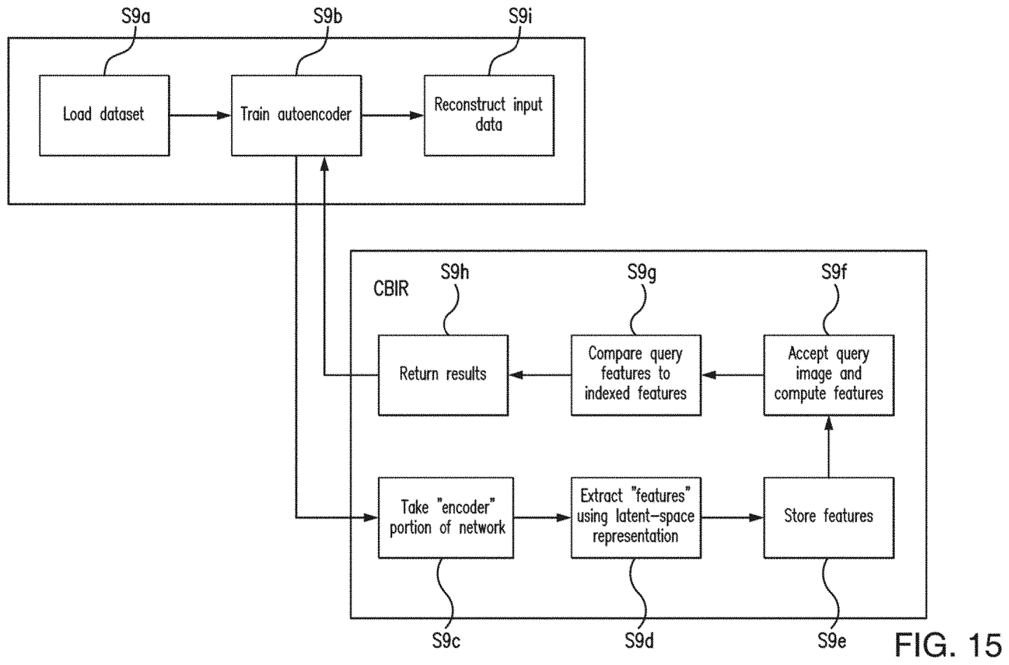

FIG. 15 shows flow chart for a CBIR operation with an object recognition algorithm. In this example, a user loads a dataset into the object recognition algorithm (S9a) and the dataset is passed to an autoencoder (S9b). The loaded dataset is delivered to the encoder portion of the autoencoder (S9c) for further training, in which one or more key features are extracted from the dataset into feature vectors (S9d) and a compressed data set is stored (S9e) for future comparisons and resampling. Upon receiving a query for object recognition and computation of features (S9f), a comparison will be made between the queried features and the indexed feature vectors (S9g), and the closest matching results will be returned to the autoencoder (S9h,S9b) for decoding and reconstruction of the input dataset (S9i).

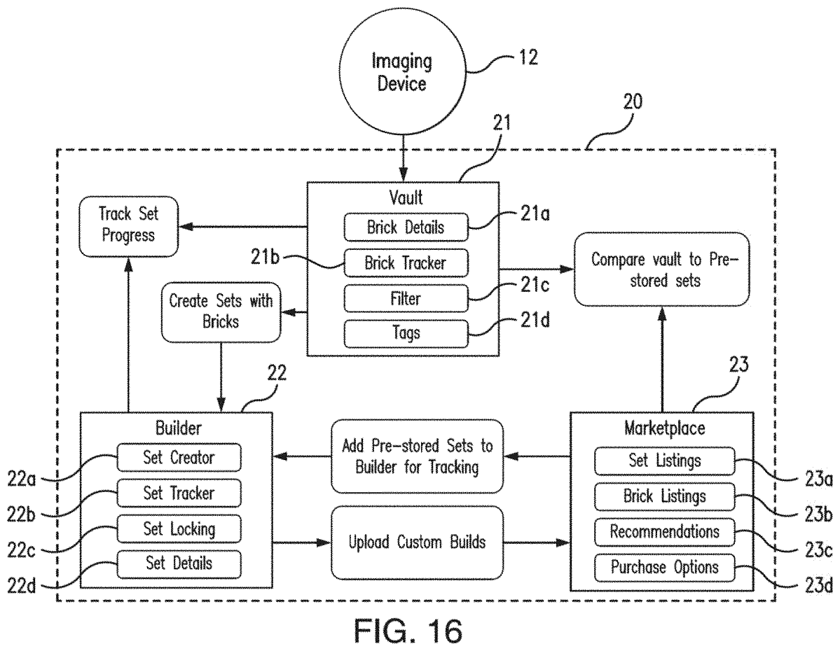

FIG. 16 shows another view of a system 1 according to the present invention, with further details as to an object management system for managing an inventory of user's object collection, as well as a supply and allocation of objects for use in projects. The system 1 includes an imaging device 12 and a processor 20. As discussed previously, the imaging device 12 is adapted for capturing images of objects (e.g., building blocks) for identifying those objects and object types that are present in a user's collection, and for adding them to a digitally stored inventory. In this example, the processor 20 includes a vault 21 (e.g., a user-specific inventory) that contains a listing of all the user's available objects and overall collection; a project builder 22 that is programmed to for conveying to the user associated sets of objects that are present in the user's object collection, as well as conveying to the user a listing of projects that may be undertaken with associated sets of objects in the user's collection; and a marketplace 23 that provides an interface for a user to acquire additional objects, object sets and projects.

In the example illustrated in FIG. 16, the system 1 is used to manage an inventory of objects in the form of building blocks for use in projects in the form of block constructs that may be assembled from the building blocks. Though the following discussion addresses this illustrated example, it will be understood that the invention is not limited to objects and projects in the form of building blocks and block constructs respectively, and that the invention is equally applicable to other objects and projects.

The vault 21 maintains an inventory of a user's collection building blocks. A block details module 21a identifies each building block present in the user's collection, and provides details on each building block, including the part type, appearance, and price of each block. A block tracker 21b stores usage data on every building block in the user's collection, which may include current and historical usage data of each building block in assembling current and prior block constructs as well as potential usages of each block in block constructs that have not yet been undertaken by the user. A filter module 21c contains various filtering scripts for a user to execute in sorting and searching for individual building blocks based on different search criteria such as certain predetermined block characteristics, which may include through are not limited to block type, block set, block theme, and block color. A tagging module 21d enables a user to tag the records of individual building blocks with custom search tags for enhancing inventory management and filtered searching of the block collection through customizable identifiers that may be employed in searches conducted through the filter module 21c.

The project builder 22 is programmed to for conveying to the user associated sets of building blocks that are present in the user's block collection, as well as conveying block constructs that the user may undertake with associated sets of building blocks in the user's block collection. A set creator 22a enables a user to develop custom block constructs based on the available building blocks present in their personal block collection that is stored in the vault 21. A user may employ the set creator 222a to generate custom block constructs conceived by the user themselves, though may also use the set creator 22a to identify pre-determined block constructs. A set tracker 22b allows a user to track real-time progress towards the completion of one or more block constructs that have been developed in the set creator 22a, and a set locker 22c enables a user to set a “use-status” of a building block, indicating whether a specific building block is currently in use in a block construct as well as the particular block construct in which a building block is currently in use. When a user's block collection includes multiple units of an identical building block type, the set locker 22c may provide a usage status for each unit with identification of each separate block construct in which each “in use” unit may be found. A set detail database 22d stores information on all block constructs generated and/or identified by the user through the set creator 22a. The information stored in the set detail database 22d will include all information needed for building each identified block construct, including though not limited to a parts list of all required building blocks, step-by-step build instructions for assembling the block constructs, and one or more images of the block construct (e.g., images of partially assembled block constructs for use in steps-by-step assembly instruction, and/or images of completely assembled block constructs). The set detail database 22d may also identify the creator of a block construct, for example, identifying the user themselves for block constructs conceived by the user and identifying other entities for pre-determined block constructs that originated from other sources (e.g., from other users or from the original equipment manufacturer).

The block marketplace 23 provides an interface for a user to acquire additional building blocks, building block sets, and block constructs. A set listing database 23a identifies block constructs that may be completed with a predetermined set of building blocks, with identification of the end result of a block construct and a listing that identifies each building block needed for the block construct. The set listing database 23a may also interact with the inventory listing stored at the block vault 21 to compare the listing of building blocks needed for completing a block construct to the building blocks available in the user's collection and may identify which building blocks the user already has in their collection and which building blocks the user must acquire in order to complete the block construct. The set listing database 23a may also identify sources from which entire building block sets may be acquired, thereby providing the user with an option for purchasing an entire set of building blocks that are needed for completion of an identified block construct.

A block listing database 23b identifies sources for acquisition of individual building blocks that a user may seek. For example, if the set listing database 23a indicates that a user is already in possession of several building blocks that are needed for completion of a block construct, though indicates that the user is missing some necessary building blocks, then the user may employ the block listing database 23b to identify sources from which the missing building blocks may be acquired. In this way, the user is provided with an option of acquiring individual building blocks for completing a block construct without being required to purchase an entire building block set that would otherwise include duplicate units to those already present in the user's collection. The user may also employ the block listing database 23b without interaction from the set listing database 23a, for example, if the user is seeking individual building blocks to complete their personal collection and/or to complete a self-conceived block construct that is not identified in the set listing database 23a.

A recommendations database 23c is programmed to provide a user with recommended block constructs and/or building block pieces based on pre-defined criteria, such as, though not limited to popularity, relevance/similarity to building block and block sets owned and tracked by the user, the user's progress on active block constructs, and block constructs undertaken by other user's (e.g., linked friends or family members). The recommendations database 23c may interact with the user's inventory stored in the block vault 21 to determine what building blocks are present in the user's collection and may recommend block constructs that the user is capable of completing with the building blocks available in their collection. The recommendations database 23c may also determine block constructs that the user is nearly capable of completing, but for which they may be missing one or more individual building blocks and may then recommend both the block constructs and the missing building blocks that are needed for acquisition to undertake the recommended block constructs. The recommendations database 23c may also interact with the project builder 22 to assess a progress and status of a user's active block constructs and may cross-reference that block construct information with the user's inventory in the block vault 21 to then recommend individual building blocks that the user may lack in their collection and which are required for completing any active block constructs. The recommendations database 23c may also recommend projects that a user may be able to complete upon combining building blocks from their block collection with building blocks available in another linked user's block collection. The processor compares a user's object inventory with a project library to identify and recommend projects that the user may complete with the objects in their inventory. In addition to objects in a user's own library, the inventory management system may also classify and consider objects in one or more other user's libraries (e.g., shared friends or family members) to recommend projects that might be completed through cooperation of two or more users.

An acquisition database 23d provides a user with options for acquiring building blocks, and may identify options for acquiring building blocks, in either individual or bulk quantities, as well as options for acquiring entire block sets. The acquisition database 23d may also identify options for acquiring block construct blueprints that provide step-by-step instructions for completing block constructs, with the blueprints available together with or separately from individual building blocks and block sets. The acquisition database 23d may interact with the set listings database 23a, the block listing database 23b and the recommendations database 23c to identify block sets and individual building blocks that the user may acquire and may provide acquisition options for each; and a user may be re-directed to the acquisition database 23d when requesting acquisition options from any of the set listings database 23a, the block listing database 23b and the recommendations database 23c. Optionally, when informing a user that they are missing one or more building blocks and/or quantities of building block types that are required for completing a block construct, the acquisition database 23d may automatically provide the user with information and/or one or more internet accessible links to facilitate acquisition of the missing building blocks. The acquisition options may include options for the individual or bulk purchase of building blocks and block sets and may also identify promotional options through which a user might acquire individual blocks or block sets from vendors at discounted rates or by attending in-person events. The acquisition options may include purchase options from retailers and vendors, as well as purchase options from other users. Users may also use the acquisition database 23d to upload blueprints of their own self-conceived block constructs for purchase by other users of the system.

The example discussed above and shown in FIG. 16 contemplates a scenario in which the vault 21, builder 22 and marketplace 23 are each stored locally on a common processor 20. However, in other examples one or both of the builder 22 and the marketplace 23 may be stored on separate processors apart from the processor 20 storing the vault 21, and signal communications may be established between the two or more separate processors (e.g., via one or more networks such as, though not limited to, the internet) for enabling the vault 21, builder 22 and marketplace 23 to communicate with one another as discussed above.

Optionally, on each use, the processor 20 may execute an updated review of the user-specific database 512, to identify any objects that have been newly added to the user inventory, to enable accurate identification of projects that the user may successfully complete with the objects available in the user inventory. Thus, in an example where the system 1 is used with building blocks 30 for assembly of block constructs, a user may update their user-specific database 512 to identify building blocks 30 that have been newly added to their collection so that the processor 20 may more accurately identify block constructs that the user may successfully assemble with their block collection.

A universal inventory may also be provided in a universal database 514. The universal inventory may be created by capturing images of each unique object 30 that is made available from the original equipment manufacturer (OEM) for use with the system 1 and recording unique identifying characteristics of each object type (e.g., shape, color, position, surface texturing, etc.). Each object type may be imaged with an imaging device and a capture region, in the same manner as done with a user-specific database 512 or may be uploaded directly as a synthetic image without imaging of a physical piece.

Projects for completion may also be added to a project library in the universal database 514, and for each added project a corresponding project inventory is generated to list the type and quantity of each object needed to complete the project. Upon identifying the object types needed for completing a project, images and other identifying characteristics of each object type is added to the project inventory from those already captured in the universal inventory. Instructions for completing a project may be entered into the system 1, and corresponding images may be captured and stored therewith. Optionally, the project instructions may provide step-by-step instructions that detail every connection between interfaces of any two objects that are to be joined in completing a project (e.g., detailing the mating connections between any two building blocks that are to be connected in assembling a block construct), and one or more images may be captured for each project step (e.g., each assembly step of joining two building blocks with one another), as well as one or more images of the fully completed project (e.g., the fully assembled block construct). Object types and quantities, project steps, and all images of individual project steps and the finally completed project are compiled in the universal database in association with a common project identifier. For example, when used with building blocks, the building block types and quantities for a block construct of a common spacecraft, as well as the assembly steps and all related images, therefore, may be stored under a common project identifier such as “Starfighter”.

The universal database 514 may be regularly updated to include all available object types (e.g., all building blocks) that have been made available by the OEM, to serve as a universal parts inventory of all objects that are contemplated for use with the system 1 and may include information on object types that have not yet been included in a user-specific database 512. Thus, in an example where the system 1 is used with building blocks 30 for assembly of block constructs, the universal database 514 may be regularly updated to include building block types that the OEM has newly manufactured and made available, which may include advance details on new building block types that are soon to be made available from the OEM. The universal database 514 may also be updated to include new block constructs that can be assembled with inclusion of the newly added building block types, as well as newly formulated block constructs that can be constructed from prior released building block types. Newly added block constructs in the universal database 514 may be accompanied by a parts lists of all building blocks needs to complete the new block constructs, step-by-step instructions for completing each block construct, as well as images of fully assembled block constructs and images to accompany step-by-step assembly instructions for block constructs.

Creation and updating of the user and universal databases may be performed with the foregoing steps executed in a different order from that set forth above. For example, a project may first be fully completed, with one or more images captured during progress of the project, prior to identification of all unique object types and quantities needed for assembly thereof. An initial collection of the types and quantities of objects might also be identified prior to recording a step-by-step completion of the project, and the type and/or quantity of objects may be updated while completing the project, with image capturing of any newly added objects, if any change is made to the intended final form of the project during completion thereof.

Thus, in an example where the system 1 is used with building blocks and block constructs, a block construct may first be fully assembled and recorded into the database with the building blocks used to assemble that block construct then identified after completion thereof, with recordation of the individual assembly steps either during or after assembly of the block construct. Alternatively, a listing of all building blocks contemplated for use in assembling an intended block construct may be identified prior to a first assembly of the block construct and may later be updated if the finally assembled block construct required more or fewer parts than originally contemplated.

An exemplary schematic diagram of a computing device 500 for computer-implementation of the system 1, in which processes involved in the embodiments described herein may be implemented, is shown in FIG. 17. Computing device 500 is typically a programmed general-purpose computer, such as an embedded processor, system on a chip, personal computer, workstation, server system, and minicomputer or mainframe computer. Computing device 500 includes the processor 20, which may be provided as one or more processors (CPUs) 502A-502N, input/output circuitry 504, network adapter 506, and memory 508. CPUs 502A-502N execute program instructions in order to carry out the functions of the present invention. Typically, CPUs 502A-502N are one or more microprocessors, microcontrollers, processor in a system-on-chip, etc.

FIG. 17 illustrates an embodiment in which computing device 500 is implemented as a single multi-processor computer device, in which multiple processors 502A-502N share system resources, such as memory 508, input/output circuitry 504, and network adapter 506. However, the present invention also contemplates embodiments in which computing device 500 is implemented as a plurality of networked computing devices, which may be single-processor computer devices, multi-processor computer devices, or a mix thereof.

Input/output circuitry 504 provides the capability to input data to, or output data from, computing device 500. For example, input/output circuitry may include input devices, such as imaging devices, microphones, keyboards, mice, touchpads, trackballs, scanners, etc., output devices, such as speakers, video adapters, monitors, printers, etc., and input/output devices, such as, modems, etc. Input/output circuitry 504 may be used when creating and updating the universal database 514 to provide the universal inventory, the project library, and the associated data files therefor, including image capturing of object types and project instructions. Network adapter 506 interfaces computing device 500 with a network 510. Network 510 may be any public or proprietary LAN or WAN, including, but not limited to the Internet, and may be the primary means by which the multiple user devices 10 communicate with the computing device 500.

Memory 508 stores program instructions that are executed by, and data that are used and processed by, CPUs 502A-502N to perform the functions of computing device 500. Memory 508 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface. In the example shown in FIG. 17, memory 508 includes multiple user-specific databases 512A-512E for storing user-specific data for a plurality of separate users, including user captured images and user inventories; a universal database 514, for storing the universal inventory and the universal project library; and an operating system 516 that provides overall system functionality to computing device 500.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although the present invention is described with reference to particular embodiments, it will be understood to those skilled in the art that the foregoing disclosure addresses exemplary embodiments only; that the scope of the invention is not limited to the disclosed embodiments; and that the scope of the invention may encompass additional embodiments embracing various changes and modifications relative to the examples disclosed herein without departing from the scope of the invention as defined in the appended claims and equivalents thereto.

Though the foregoing discussion addresses examples in which the system is used for managing a collection of building blocks and block constructs that may be completed with such building blocks, it will be understood that the invention is not limited to objects and projects in the form of building blocks and block constructs respectively. For example, a system according to the present invention may be used with any type of object for the completion/assembly of any corresponding project—e.g., automotive parts for assembling an automobile; constructions parts for building architectural structures; computer components for assembling computing hardware; etc. Thus, any examples of the systems and methods discussed or illustrated herein relative to “building blocks” and/or “block constructs” specifically, will be understood as likewise informative of systems and methods used with other “objects” and “projects”.

The present invention is not limited to the exemplary embodiments illustrated herein, but is instead characterized by the appended claims, which in no way limit the scope of the disclosure.

What is claimed is:

1. A system for optical recognition of building blocks, comprising:
an imaging device configured to capture images of building blocks;
a memory configured to store captured images of building blocks; and
a processor configured to perform object recognition on images of building blocks, wherein
the system is configured for the imaging device to communicate with the memory for conveying captured images of building blocks for storage in the memory, and for the processor to access and perform object recognition on captured images stored in the memory to identify individual building blocks in the captured image.

2. The system according to claim 1, wherein
the processor is configured, in performing object recognition, to perform object detection to identify individual building blocks in the captured image and establish a count of each identified building block.

3. The system according to claim 1, wherein
the processor is configured, in performing object recognition, to perform localization of detected building blocks to determine a location for individual building blocks in the captured image.

4. The system according to claim 1, wherein
the processor is configured, in performing object recognition, to perform bounding to identify edges defining perimeters for individual building blocks in the captured image.

5. The system according to claim 1, wherein
the processor is configured, in performing object recognition, to perform segmentation to isolate and extract a local image for individual building blocks in the captured image.

6. The system according to claim 1, wherein
the processor is configured, in performing object recognition, to perform matching between images of building blocks in the captured image and pre-stored images in the memory to match the extracted images with corresponding pre-stored images, and, upon a successful matching of an extracted image with a pre-stored image, to designate the building block in the extracted image as a pre-defined building block type that is associated with the corresponding pre-stored image.

7. The system according to claim 1, wherein
the processor is configured, in performing object recognition, to perform:
object detection to identify individual building blocks in the captured image, and establish a count of each identified building block;
localization to determine a location for each of the individual building blocks identified in object detection of the captured image;
bounding to identify edges defining perimeters for each of the individual building blocks detected and localized in the captured image;
segmentation to isolate and extract a local image for each of the individual building blocks detected, localized and bound in the captured image; and
matching between the extracted images of the building blocks and pre-stored images in the memory to match the extracted images with corresponding pre-stored images, and, upon a successful matching of an extracted image with a pre-stored image, to designate the building block in the extracted image as a pre-defined building block type that is associated with the corresponding pre-stored image.

8. The system according to claim 1, wherein
the processor is further configured, following identification of individual building blocks in a captured image, to generate a user inventory identifying a type of each building block identified in the captured image and a quantity of each building block type identified in the captured image.

9. The system according to claim 8, wherein
the processor is further configured to cross-reference a user inventory of building blocks with a pre-stored library of block constructs to identify a list of block constructs that may be assembled with the building blocks available in the user inventory.

10. The system according to claim 9, wherein
the processor is further configured to provide a user with a list of building blocks needed for assembling a block construct from the pre-stored library together with instructions for assembling the block construct.

11. The system according to claim 9, wherein
the processor is further configured, when cross-referencing a user inventory of building blocks with a pre-stored library of block constructs, to compare the user inventory of building blocks with a build inventory of building blocks required for assembling a block construct, and to identify building blocks that are required by the build inventory and missing from the user inventory.

12. The system according to claim 11, wherein
the processor is further configured, when identify building blocks that are required by the build inventory and missing from the user inventory, to provide a means for a user to acquire the missing building blocks.

13. The system according to claim 12, wherein
the processor is configured to provide contact information for a third party that is offering the missing building blocks for sale.

14. The system according to claim 12, wherein
the processor is configured to provide a link to a website where the missing building blocks are available for purchase.
